(19) United States
(12) Patent Application Publication
(10) Pub. No.: US 2010/0027275 A1
(43) Pub. Date: Feb. 4, 2010

(54) Light guide plate for liquid crystal display and process for producing same

(75) Inventors: Tadahiro Ohmi, Sendai-shi (JP); Naoki Tanahashi, Sendai-shi (JP); Masahiko Hayashi, Tokyo (JP)

Correspondence Address: BIRCH STEWART KOLASCH & BIRCH, PO BOX 747, FALLS CHURCH, VA, 22040-0747, US

(73) Assignees: Tadahiro Ohmi, Sendai-shi (JP); Zeon Corporation, Tokyo (JP)

(21) Appl. No.: 11/547,388

(22) PCT Filed: Mar. 31, 2005
(86) PCT No.: PCT/JP2005/006283

§ 371 Date: Jun. 3, 2009

(30) Foreign Application Priority Data
Mar. 31, 2004 (JP) 2004-108182

(51) Int. Cl. F21V 11/00; B05D 5/06

(52) U.S. Cl. 362/351; 427/162; 362/97.1

(57) ABSTRACT

A light guide plate for liquid crystal display, made of a resin, which has a surface layer portion (preferably on the light incident surface side of the light guide plate) comprising a region containing fluorine atoms in an amount larger than that in the inner layer portion. The resin is preferably an alicyclic structure-containing resin. The light guide plate is produced by exposing a surface of a light guide plate substrate to an atmosphere containing fluorine gas. Preferably, prior to the exposure to a fluorine-gas containing atmosphere and after the exposure to a fluorine-gas containing atmosphere, the light guide plate substrate is maintained in an inert gas-containing atmosphere, or in the air under reduced pressure, for the production of the light guide plate.

### TECHNICAL FIELD

This invention relates to a light guide plate made of resin, and a process for producing the light guide plate. More particularly, this invention relates to a light guide plate made of a resin and containing a large amount of fluorine atoms in a surface layer thereof, which has good heat resistance and good anti-light-reflection and liquid crystal display surface of which exhibits enhanced luminance; and further it relates to a process for producing the light guide plate.

### BACKGROUND ART

The inner crystalline structure of liquid crystal varies upon imposition of electric voltage, with the result that its transmissive property varies. A liquid crystal display device utilizing this principle is used for personal computer displays and televisions. The liquid crystal display device is classified into, for example, the following technologies: IPS, VA and OCB, depending upon the manner of variation of transmissive property upon imposition of electrical voltage. Thin film transistor (TFT) technology is predominantly applied in a liquid crystal display device for personal computer because of high image quality and high-speed response to a moving image.

A liquid crystal display (LCD) device includes a reflective type LCD device and a back-light transmissive type LCD device. The reflective type LCD device itself does not emit light to develop images, and is illuminated by external light received from the outside and reflected by a reflector behind the display device. The back-light transmissive LCD device has a light source within the device and is illuminated from the back by a backlight surface light source to develop an image.

The backlight surface light source of LCD device includes a side light system (or a light guide plate system) wherein a linear light source such as a fluorescent lamp is provided adjacent to a side of the display surface, and light beams from the liner light source are introduced at the side thereof and transmitted through a light guide plate along a plate surface and emit in the direction perpendicular to the plate surface; and a direct type wherein light sources are provided at backside and light beams are transmitted from the backside to emit from the opposite side. In the direct type, light beams are directly transmitted from the backside in the LCD, and therefore, an image of high luminance level can be attained, but the thickness of LCD device cannot be reduced to a sufficient extent due to the thickness of an array of light sources.

In the light guide plate system, a light source is provided adjacent to a side of LCD device and therefore the thickness of LCD device can be thin. However, in this type device, the light beams from the linear light source are spread on the entire surface and emit in the perpendicular direction from the entire surface, and therefore, an image of high luminance level cannot be attained.

To enhance the luminance level in the light guide plate type device, attempts of conducting a special treatment on the light emitting surface or reflecting surface of the light guide plate have been made to minimize the leakage of light. For example, a dotted pattern, a prisms-shaped or a craped pattern is imparted on the reflecting surface by the treatment. A prisms-shaped or a craped pattern is imparted on the light emitting surface by the treatment.

An attempt of reducing light reflectivity on the light incident surface on a side of the light guide plate has been made. For example, a light guide plate with an optical path length of at least 50 mm, which has a light incident surface provided with an antireflection layer, has been proposed in Japanese Unexamined Patent Publication (JP-A) No. 2001-311829. The antireflection layer disclosed therein is made of a film of an inorganic compound such as SiO₂ or ZrO₂, which is formed on the light incident surface by vapor deposition or sputtering. Alternatively, the antireflection layer is made of a resin (e.g., fluororesin) having a refractive index lower than that of a resin constituting the light guide plate, which layer is formed by coating the light incident layer with the low refractive index resin.

In a conventional reflective type LCD device, the display image can be viewed only in light environments. To solve this problem, a front-light type surface light source has been developed wherein a light guide plate is provided so as to confront the front surface of an LCD substrate. In this front light type surface light source, the light beams, which are introduced in the light guide plate through the light incident surface thereof from a light source provided adjacent to the light incident surface thereof, are spread over the entire light emitting surface, and emitted from the entire light emitting surface. The emitted light beams are incident on an LCD substrate and reflected by a reflecting plate provided on the back side of the LCD substrate. A display image can be viewed even in dark environments. However, the display image utilizing the front-light type surface light source is occasionally difficult to clearly view because of bright light reflection. To solve this problem, i.e., minimize the reduction of visibility, a proposal has been made of providing an antireflection layer on the light emitting surface of the light guide plate, or on both of the light emitting surface of the light guide plate and the light incident surface of the LCD substrate in JP-A 2003-240963. The antireflection layer in this proposal is comprised of a film formed by vapor deposition.

The above-mentioned antireflection layers formed on the light guide plate surface have problems in that the laminate bond strength of antireflection layers and transparency thereof are often poor.

It has been proposed in JP-A 2000-95862 that, for cladding formation in an optical fiber or an optical beam waveguide, a transparent resin is brought into contact with a fluorine gas to desirably control the refractive index of the resin. However, this refractive index-controlling technique has heretofore not been attempted in a light guide plate for LCD.

### DISCLOSURE OF THE INVENTION

### Problems to Be Solved by the Invention

The present inventors made extensive researches on surface treating technology of a light guide plate made of a resin, to improve the luminance in a back-light transmissive type LCD device using the light guide plate of resin, and to minimize the undesirable light reflection or Moire in a front light type LCD device utilizing a front light type surface light source with the light guide plate of resin. As the results, it has been found that a desired light guide plate exhibiting lowered light reflectivity and high light transmittance, and good water-repellency and good stain resistance, while adhesion failure and reduction of transparency do not occur when an inorganic substance film is laminated, can be obtained by forming a surface layer portion of the light guide plate of resin which portion has a region containing a larger amount of fluorine atoms than that in the inner layer portion of the light guide plate. It has been further found that, when the above-mentioned light guide plate is equipped in an LCD device utilizing the backlight surface light source, the luminance of display surface is greatly enhanced. It has been further found that the above-mentioned fluorine-incorporated light guide plate can be easily obtained by exposing a light guide plate substrate to an atmosphere containing fluorine gas. The present invention has been completed based on the above-mentioned findings.

### Means for Solving the Problems

A light guide plate for liquid crystal display according to the present invention comprises a light guide plate made of a resin, characterized as having a surface layer portion comprising a region containing fluorine atoms in an amount larger than that in the inner layer portion.

The light guide plate for liquid crystal display according to the present invention may have the region containing a larger amount of fluorine atoms in a surface layer portion on the light incident side and/or in a surface layer portion on the light emitting side. Preferably the region containing a larger amount of fluorine atoms is provided in a surface layer portion on the light incident side.

The resin is preferably an alicyclic structure-containing resin.

A process for producing a light guide plate for liquid crystal display according to the present invention is characterized as comprising a step of exposing a surface of a light guide plate substrate made of a resin, to an atmosphere containing fluorine gas.

A preferred embodiment of the process for producing alight guide plate for liquid crystal display according to the present invention comprises a step of placing the light guide plate substrate in an inert gas-containing atmosphere, or in the air under reduced pressure, prior to the step of exposing to a fluorine-gas containing atmosphere; and further comprises a step of again placing the light guide plate substrate in an inert gas-containing atmosphere, or in the air under reduced pressure, after the step of exposing to a fluorine-gas containing atmosphere.

The resin used is preferably an alicyclic structure-containing resin.

The atmosphere containing fluorine gas is preferably a fluorine-containing gas which has been diluted with an inert gas and contains a fluorine gas at a concentration in the range from 0.1 to 50% by volume. The content of each of oxygen and moisture in the light guide plate substrate immediately before the step of exposing to a fluorine-gas containing atmosphere is preferably not larger than 1% by weight. The content of each of oxygen and moisture in the fluorine-gas containing atmosphere immediately before the step of exposing thereto is preferably not larger than 100 ppm by weight. The surface of the light guide plate substrate is exposed to the fluorine gas-containing atmosphere while the surface of the light guide plate substrate is maintained at a temperature in the range from −50 to 150° C.

When the light guide plate substrate is placed in an inert gas-containing atmosphere, the light guide plate substrate is preferably maintained at a temperature in the range from 60 to 180° C., and, when the light guide plate substrate is placed in the air under reduced pressure, the light guide plate substrate is preferably maintained at a temperature in the range from 15 to 100° C. in the air under reduced pressure. The reduced pressure is preferably in the range from 1 to 500 mmHg.

### EFFECT OF THE INVENTION

The light guide plate for liquid crystal display according to the present invention has a surface layer portion comprising a region containing a larger amount of fluorine atoms. The region containing a larger amount of fluorine atoms in a surface layer portion has a refractive index lower than that of a region in the inner layer portion which does not contain or contains a small amount of fluorine atoms. Due to the low refractive index in a surface layer portion of the light guide plate of the present invention, the light guide plate exhibits a desirably low light reflectivity. The entire body of light guide plate is uniformly composed of a resin or a resin composition, and thus, there is no interface between different substances as found in a laminate composed of different resin layers. Therefore, there are no problems such as adhesion failure or separation of a film or occurrence of cracks, and, the light guide plate has high mechanical strength.

When the content of fluorine atoms is inclined from the surface layer portion to the inner layer portion, the light guide plate exhibits a refractive index which is distributed with gradient.

By providing a back-light transmissive type LCD device with the light guide plate of the present invention having the above-mentioned benefits, the luminance of image can be enhanced. By providing a front light type LCD device with the light guide plate of the present invention having the above-mentioned benefits, the undesirable light reflection or occurrence of Moire can be minimized. By conducting the process of the present invention, the light guide plate of the present invention can be easily produced.

### BRIEF DESCRIPTION OF THE DRAWINGS

FIG. 1 is a diagram illustrating an example of a reaction apparatus used in the process for producing the guide light plate of the present invention.

FIG. 2 is a perspective diagram illustrating an example of a guide light plate of the present invention for use in a back light type LCD device.

FIG. 3 is a perspective diagram illustrating an example of a guide light plate of the present invention for use in a front light type LCD device.

FIG. 4 is a front elevation illustrating an example of a connected type light guide plate of the present invention, and a side elevation illustrating the same light guide plate.

FIG. 5 is a front elevation illustrating another example of a connected type light guide plate of the present invention, and a side elevation illustrating the same light guide plate.

FIG. 6 is a front elevation illustrating still another example of a connected type light guide plate of the present invention, and a side elevation illustrating the same light guide plate.

FIG. 7 is a front elevation illustrating a further example of a connected type light guide plate of the present invention, and a side elevation illustrating the same light guide plate.

FIG. 8 is a front elevation illustrating a further example of a connected type light guide plate of the present invention, and a side elevation illustrating the same light guide plate.

FIG. 9 is a front elevation illustrating a further example of a connected type light guide plate of the present invention, and a side elevation illustrating the same light guide plate.

FIG. 10 is a front elevation illustrating a further example of a connected type light guide plate of the present invention, and a side elevation illustrating the same light guide plate.

### BEST MODE FOR CARRYING OUT THE INVENTION

The light guide plate for liquid crystal display according to the present invention is characterized in that the light guide plate is made of a resin and has a surface layer portion comprising a region containing fluorine atoms in an amount larger than that in the inner layer portion.

The resin constituting the light guide plate of the present invention is a resin transparent to a desired wave length. The transparent resin includes, for example, an acrylic resin, a polycarbonate resin, a polyester resin, a polyolefin resin and an alicyclic structure-containing resin. Of these, an alicyclic structure-containing resin is preferable.

The alicyclic structure-containing resin is a resin having alicyclic structures in the main chain and/or side chains. A resin having alicyclic structures in the main chain is preferable in view of mechanical strength and heat resistance. The alicyclic structures include, for example, a cycloalkane structure and a cycloalkene structure. A cycloalkane structure is especially preferable because of high mechanical strengths and high heat resistance. The alicyclic structure may be either a monocyclic structure, or a polycyclic structure such as a condensed polycyclic structure or a crosslinked polycyclic structure. The number of carbon atoms contained in the alicyclic structure is not particularly limited, but is usually in the range from 4 to 30, preferably 5 to 20 carbon atoms and more preferably 5 to 15 in view of high and well-balanced mechanical strength, heat resistance and shapability. The alicyclic structure-containing resin used in the present invention is usually thermoplastic.

The alicyclic structure-containing resin usually comprises repeating units derived from an alicyclic structure-containing olefin (hereinafter referred to as “alicyclic olefin” when appropriate). The proportion of the repeating units derived from an alicyclic olefin in the alicyclic structure varies depending upon the particular use thereof, but is usually in the range from 30 to 100% by weight, preferably 50 to 100% by weight and more preferably 70 to 100% by weight. If the proportion of the repeating units derived from an alicyclic olefin is too small, the heat resistance is poor. The repeating units other than the repeating units derived from an alicyclic olefin are not particularly limited, and can appropriately be chosen depending upon the intended use thereof.

The alicyclic structure-containing resin may have polar groups. As preferable examples of the polar group, there can be mentioned a hydroxyl group, a carboxyl group, an alkoxy group, an epoxy group, a glycidyl group, an oxycarbonyl group, a carbonyl group, an amino group, an ester group, a carboxylic anhydride residue group, an amide group and an imide group. Of these, an ester group, a carboxyl group and a carboxylic anhydride residue group are especially preferable.

The alicyclic structure-containing resin is usually produced by a process wherein an alicyclic olefin is subjected to addition polymerization or ring-opening polymerization, and, if desired, the unsaturated bonds of the resulting polymer is hydrogenated; or an aromatic olefin is subjected to addition polymerization, and the aromatic rings of the resulting polymer are hydrogenated. The alicyclic structure-containing resin having polar groups is produced, for example, by a process wherein the above-mentioned alicyclic structure-containing resin is subjected to modification reaction with a polar group-containing compound, thereby to introduce polar groups in the resin; or a polar group-containing monomer is copolymerized as a comonomer when the alicyclic structure-containing resin is prepared by polymerization.

As examples of the alicyclic olefin used for the production of the alicyclic structure-containing resin, there can be mentioned unsaturated hydrocarbons with a polycyclic structure and their derivatives, which include norbornene series monomers such as norbornene, dicyclopentadiene, tetracyclododecene, ethyltetracyclododecene, ethylidenetetracyclododecene, tetracyclo[7.4.0.1^{10,13}.0^{2,7}]-trideca-2,4,6,11-tetraene, and 1,4-methano-1,4,4a,9a-tetrahydrofluorene; and unsaturated hydrocarbons with a monocyclic structure and their derivatives, such as cyclobutene, cyclopentene, cyclohexene, 3,4-dimethylcyclopentene, 3-methylcyclohexene, 2-(2-methylbutyl)-1-cyclohexene, cyclooctene, cyclopheptene, cyclopentadiene and cyclohexadiene. These cycloolefins may have polar groups as substituents. As examples of the aromatic olefin, there can be mentioned styrene, α-methylstyrene and divinylbenzene. The alicyclic olefins and/or the aromatic olefins may be used either alone or as a combination of at least two thereof.

If desired, a monomer copolymerizable with the alicyclic olefin or the aromatic olefin can be copolymerized in the addition copolymerization. As specific examples of the copolymerizable monomer, there can be mentioned α-olefins having 2 to 20 carbon atoms, such as ethylene, propylene, 1-butene, 1-pentene, 1-hexene, 3-methyl-1-butene, 3-methyl-1-pentene, 3-ethyl-1-pentene, 4-methyl-1-penetene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene and 1-eicosene; non-conjugated dienes such as 1,4-hexadiene, 4-methyl-1,4-hexadiene, 5-methyl-1,4-hexadiene and 1,7-octadiene; and conjugated dienes such as 1,3-butadiene and isoprene. These monomers may be used either alone or as a combination of at least two thereof.

The polymerization of the alicyclic olefins and/or the aromatic olefins can be carried out by the conventional procedure. The polymerization temperature, pressure and other conditions are not particularly limited, but, the polymerization temperature is usually in the range from −50° C. to 100° C., and the polymerization pressure is usually in the range from 0 to 50 kgf/cm². The hydrogenation reaction is carried out by blowing hydrogen in the presence of a known hydrogenation catalyst.

As specific examples of the alicyclic structure-containing resin, there can be mentioned a ring-opened polymer of a norbornene series monomer, and a hydrogenation product thereof; an addition polymer of a norbornene series monomer; an addition copolymer of a norbornene series monomer with a vinyl monomer such as ethylene or an α-olefin; a polymer of a monocycloalkene monomer; a polymer of an alicyclic conjugated diene monomer, and a hydrogenation product thereof; a polymer of a vinyl-alicyclic hydrocarbon monomer, and a hydrogenation product thereof; and an aromatic ring-hydrogenated product of an aromatic olefin polymer. Of these, a ring-opening polymerization polymer of a norbornene monomer and a hydrogenation product thereof, an addition polymer of a norbornene series monomer, an addition copolymer of a norbornene series monomer with a vinyl monomer, and an aromatic ring-hydrogenated product of an aromatic olefin monomer are preferable. A hydrogenation product of a ring-opening polymerization polymer of a norbornene series monomer is especially preferable. These alicyclic structure-containing resins may be used either alone or as a combination of at least two thereof.

The molecular weight of the resin used in the present invention is not particularly limited. Usually, the weight average molecular weight (Mw) of resin is in the range from 1,000 to 1,000,000, preferably 5,000 to 50,000 and more preferably 10,000 to 250,000 as measured gel permeation chromatography (GPC) using cyclohexane (when the resin is insoluble in cyclohexane, toluene is used) as solvent and expressed in terms of Mw of polystyrene. When the weight average molecular weight (Mw) of resin is in the above-ranges, the resin has well-balanced heat resistance and surface smoothness.

The molecular weight distribution of the resin as expressed by the ratio (Mw/Mn) of weight average molecular weight (Mw) to number average molecular weight (Mn) as measured by GPC using cyclohexane (when the resin is insoluble in cyclohexane, toluene is used) as solvent is usually not larger than 5, preferably not larger than 4 and more preferably not larger than 3.

The glass transition temperature of the resin may be appropriately chosen depending upon the particular use of the resin, but, is preferably at least 70° C., more preferably at least 100° C. and most preferably at least 120° C.

The resin used in the present invention may have incorporated therein ingredients such as a colorant such as pigment and dye, a fluorescent brightener, a dispersant, a heat stabilizer, a light stabilizer, an ultraviolet absorber, a near infrared absorber, an antistatic agent, an antioxidant, a lubricant, a solvent, a plasticizer and a release agent.

Of the above-recited ingredients, an antioxidant and/or a light stabilizer is especially preferable. The antioxidant includes, for example, a phenolic antioxidant, a phosphorus-containing antioxidant and a sulfur-containing antioxidant. Of these, a phenolic antioxidant is preferable. An alkyl-substituted phenolic antioxidant is especially preferable.

As specific examples of the phenolic antioxidant, there can be mentioned alkyl-substituted phenolic compounds such as octadecyl-3-(3,5-di-t-butyl-4-hydroxyphenyl) propionate, 2,2′-methylene-bis(4-methyl-6-t-butylphenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis-methylene-3-(3′,5′-di-t-butyl-4′-hydroxyphenylpropionate)-methane [namely, pentaerythrityl-tetrakis-3-(3,5-di-t-butyl-4-hydroxyphenyl propionate); acrylate compounds such as 2-t-butyl-6-(3-t-butyl-2-hydroxy-5-methylbenzyl)-4-methylphenyl acrylate and 2,4-di-t-amyl-6-{1-(3,5-di-t-amyl-2-hydroxyphenyl)ethyl}phenyl acrylate; and triazine group-containing phenolic compounds such as 6-(4-hydroxy-3,5-di-t-butylanilino)-2,4-bisoctylthio-1,3,5-triazine and 4-bisoctylthio-1,3,5-triazine.

As specific examples of the phosphorus-containing antioxidant, there can be mentioned monophosphite compounds such as triphenyl phosphite, diphenylisodecyl phosphite, phenyldiisodecyl phosphite, tris(nonylphenyl) phosphite, tris(dinonylphenyl) phosphite and tris(2,4-di-t-butylphenyl) phosphate; and diphosphite compounds such as 4,4′-butylidene-bis(3-methyl-6-t-butylphenyl-di-tridecyl phosphite).

As specific examples of the sulfur-containing antioxidant, there can be mentioned dilauryl 3,3′-thiodipropionate, dimyristyl 3,3′-thiodipropionate, distearyl 3,3′-thiodipropionate and laurylstearyl 3,3′-thiodipropionate.

These antioxidants may be used either alone or as a combination of at least two thereof. The amount of the antioxidant is usually in the range from 0.01 to 2 parts by weight, preferably from 0.02 to 1 part by weight and more preferably from 0.05 to 0.5 part by weight, based on 100 parts by weight of the resin.

The light stabilizer includes hindered amine light stabilizers (HALS) and benzoate light stabilizers. Of these, hindered amine light stabilizers are preferable.

As specific examples of HALS, there can be mentioned bis(2,2,6,6-tetramethyl-4-piperidyl) sebacate, bis(1,2,2,6,6-pentamethyl-4-piperidyl) sebacate, 1-[2-{3-(3,5-di-t-butyl-4-hydroxyphenyl)propionyloxy}ethyl]-4-{3-(3,5-di-t-butyl-4-hydroxyphenyl)propionyloxy}-2,2,6,6-tetramethylpiperidine, 8-benzyl-7,7,9,9-tetramethyl-3-octyl-1,2,3-triazaspiro-[4,5]undecane-2,4-dione, 4-benzoyloxy-2,2,6,6-tetramethylpiperidine, a polycondensate of dimethyl succinate with 1-(2-hydroxyethyl)-4-hydroxy-2,2,6,6-tetramethylpiperidine, poly[{6-(1,1,3,3-tetramethylbutyl)-amino-1,3,5-triazine-2,4-diyl}{(2,2,6,6-tetramethyl-4-piperidyl)imino}hexamethylene{(2,2,6,6-tetramethyl-4-piperidyl)imino}], a condensate of N,N′-bis(3-aminopropyl)ethylenediamine with 2,4-bis[N-butyl-N-(1,2,2,6,6-pentamethyl-4-piperidyl)amino]-6-chloro-1,3,5-triazine, tetrakis(2,2,6,6-tetramethyl-4-piperidyl) 1,2,3,4-butanetetracarboxylate, a condensate of 1,2,3,4-tetracarboxylic acid with 1,2,2,6,6-tetramethyl-4-piperidinol and with tridecyl alcohol, N,N′,N″,N′″-tetrakis-(4,6-bis-(butyl-(N-methyl-2,2,6,6-tetramethylpiperidin-4-yl) amino)triazin-2-yl)-4,7-diazadecane-1,10-diamine, a polycondensate of dibutylamine with 1,3,5-triazine and with N,N′-bis(2,2,6,6-tetramethyl-4-piperidyl) butylamine, poly[{1,1,3,3-tetramethylbutyl)amino-1,3,5-triazine-2,4-diyl}{(2,2,6,6-tetramethyl-4-piperidyl) imino}]hexamethylene-{(2,2,6,6-tetramethyl-4-piperidyl)imino}], a polycondensate of 1,6-hexanediamine-N,N′-bis(2,2,6,6-tetramethyl-4-piperidyl) with morpholine-2,4,6-trichloro-1,3,5-traiazine, poly[(6-morpholino-s-triazine-2,4-diyl) [(2,2,6,6-tetramethyl-4-piperidyl) imino]hexamethylene[(2,2,6,6-tetramethyl-4-piperidyl)imino], a polycondensate of dimethyl succinate with 4-hydroxy-2,2,6,6-tetramethyl-1-piperidineethanol, and a mixed esterified product of 1,2,3,4-butanetetracarboxylic acid and 1,2,2,6,6-pentamethyl-4-piperidinol and 3,9-bis(2-hydroxy-1,1-dimethylethyl)-2,4,8,10-tetraoxaspiro[5,5]undecane.

Of these, those which have a number average molecular weight in the range from 2,000 to 5,000 and are selected from a polycondensate of dibutylamine with 1,3,5-triazine and with N,N′-bis(2,2,6,6-tetarmethyl-4-piperidyl)butylamine, poly[{(1,1,3,3-tetramethylbutyl)amino-1,3,5-triazine-2,4-diyl }{(2,2,6,6-tetramethyl-4-piperidyl)imino}]hexamethylene-[(2,2,6,6-tetramethyl-4-piperidyl) imino], and a polycondensate of dimethyl succinate with 4-hydroxy-2,2,6,6-tetramethyl-1-piperidineethanol are preferable.

The above-mentioned light stabilizers may be used either alone or as a combination of at least two thereof. The amount of the light stabilizer is usually in the range from 0.0001 to 5 parts by weight, preferably from 0.001 to 1 part by weight and more preferably from 0.01 to 0.5 part by weight, based on 100 parts by weight of the resin.

A light dispersant can be incorporated in the resin used in the present invention. By the incorporation of light dispersant, incident light can be internally distributed and effectively emit in the perpendicular direction. The light dispersant used is comprised of transparent particles, or fine particles such that they are capable of being dispersed with a particle diameter of such an extent that the particles are transparent to visible light. As specific examples of the light dispersant particles, there can be mentioned fluororesin particle, silicone resin particle, crosslinked silicone resin particles, polystyrene particle, acrylic resin particle, calcium carbonate powder, silica powder, talc powder and barium sulfate powder.

The shape of the light guide plate for LCD of the present invention is not particularly limited and may be of conventional shape. A typical example of the shape is a wedge-shape. A wedge-shaped light guide plate may have various surface configurations on the incident surface and the emitting surface. The configurations include, for example, dots, crapes, prisms, lines, line-dots and crepe dots. A plurality of wedge-shaped light guide plates can be connected in series or in a confronting manner.

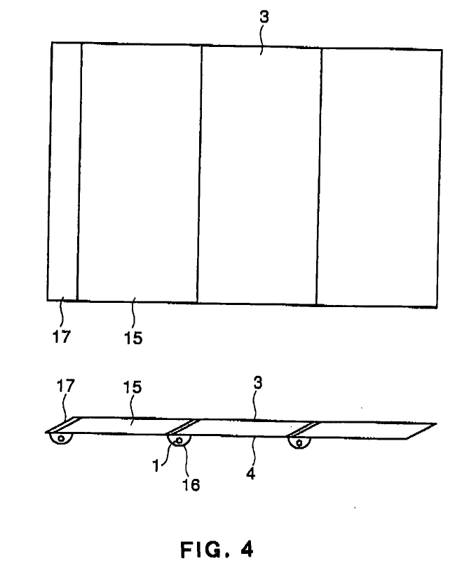

Examples of the connected type light guide plate will be specifically described with reference to FIG. 4 to FIG. 10.

FIG. 4 is a front elevation illustrating an example of the connected type light guide plate of the present invention, and a side elevation illustrating the same light guide plate. In this example, the light guide plate is constituted by three flat plate-shaped light guide plate 15. Each light guide plate 15 has a light source 1 provided at an end of the light reflecting surface 4. The light source 1 is covered by a reflector 16. The connected sides of each light guide plate 15 form an inclined surface 17. The inclined surface 17 is provided with a light control means. Therefore, the light beams from the light source do not emit directly from the emitting surface 3 whereby a large size display image exhibiting uniform luminance can be obtained. The light control means includes, for example, a light-reflecting prisms-shaped means, and a light blocking means printed with a black or white ink.

In the above-mentioned connected type light guide plate, each light guide plate can have a pin-point gate located on the inclined surface provided with a light control means. Therefore, even if a plurality of light guide plates are connected, a large size display image which is not influenced by pin-point gate marks can be obtained. The connected type light guide plate is manufactured by connecting light guide plates having the same shape, and thus, the production can be carried out at a low cost. Each flat plate-shaped light guide plate constituting the above-mentioned connected type light guide plate has an approximately uniform thickness, and therefore, the light guide plates can be produced in a high yield even if the molding conditions are varied.

In the specific example shown in FIG. 4, three light guide plates are connected. However, the number of light guide plates connected may be any of at least two. This type of connected light guide plate can have a diffusion sheet laminated on the light emitting surface. As a modification, a single flat plate-shaped light guide plate shown in FIG. 4 may be used alone.

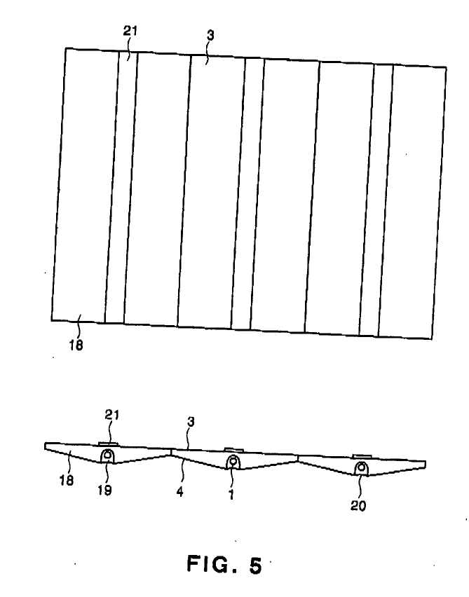

FIG. 5 is a front elevation illustrating another example of the connected type light guide plate of the present invention, and a side elevation illustrating the same light guide plate. This connected type light guide plate is constituted by three light guide plates 18 each having a two-wings section. Each light guide plate 18 has a recess 19 formed on the light-reflecting surface side 4. A light source 1 is provided in each recess 19, and the recess 19 is covered by a reflector 20. Each light guide plate 18 has a light control means 21 fitted on the light emitting surface at a position confronting the light source 1. By controlling the light beams transmitted directly from the light source 1 toward the emitting surface 3, a large size display image having uniform luminance can be obtained. The light control means 21 includes, for example, a light-reflecting prisms-shaped means, and a light blocking means printed with a black or white ink, which is printed, for example, in a dotted pattern.

In the specific example shown in FIG. 5, three light guide plates each having a two-wings section are connected. As a modification, a light guide plate having a one-piece structure can be used which has the same shape as the connected type light guide plate.

In the connected type light guide plate shown in FIG. 5, the greater part of light beams is transmitted directly from the light source into the light guide plate, and therefore, utilization efficiency of light is high. The distance of light transmission from the light source is short, and hence, the uniformity of luminance is very high. The connected type light guide plate which is comprised of connected three light guide plates can be produced at a low cost. The light guide plate having a one-piece structure has no seam and therefore a display image of very high quality can be obtained.

In the specific example shown in FIG. 5, three light guide plates each having a two-wings section are connected. The number of light guide plates connected may be any of at least two. This type of connected light guide plate can have a diffusion sheet laminated on the light emitting surface. As a modification, a single light guide plate having a two-wings section as illustrated in FIG. 5 may be used alone.

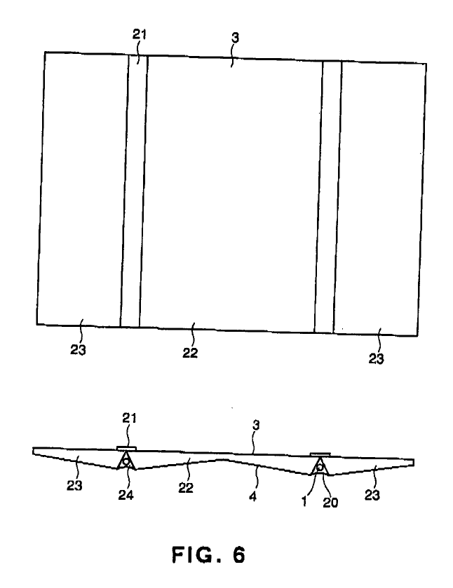

FIG. 6 is a front elevation illustrating still another example of the connected type light guide plate of the present invention, and a side elevation illustrating the same light guide plate. This connected type light guide plate is constituted by one light guide plate 22 having a two-wings section and two light guide plates 23 each having a single wing section. A recess 24 is formed in each connection on the light reflecting surface side 4 between each light guide plate having a single wing section and each light guide plate having a two-wings section. A light source 1 is provided in the recess 24, and the recess 24 is covered by a reflector 20. A light control means 21 is fitted on the light emitting surface 3 at a position confronting the light source 1. By controlling the light beams transmitted directly from the light source 1 toward the emitting surface 3, a large size display image without unevenness in luminance can be obtained. The light control means 21 includes, for example, a light-reflecting prisms-shaped means, and a light blocking means printed with a black or white ink, which is printed, for example, in a dotted pattern.

In the connected type light guide plate shown in FIG. 6, the greater part of light beams is transmitted directly from the light source into the light guide plate, and therefore, utilization efficiency of light is high. The distance of light transmission from the light source is short, and hence, the unevenness in luminance is greatly reduced. The connected type light guide plate is influenced by seams only to a minimized extent, and therefore, a display image having high quality can be obtained.

In the specific example shown in FIG. 6, the connected type light guide plate is comprised of a single light guide plate having a two-wings section and two light guide plates each having a wing section. As a modification, at least two light guide plates each having a two-wings section may be connected, and two light guide plates each having a wing section are connected to both ends of the connected at least two light guide plates. As another modification, two light guide plates each having a wing section may be used instead of a single light guide plate having a two-wings section, namely, the connected type light guide plate may be made only from light guide plates each having a wing section. The latter connected type light guide plate is made from one kind of light guide plate, and therefore, it is produced with a low cost.

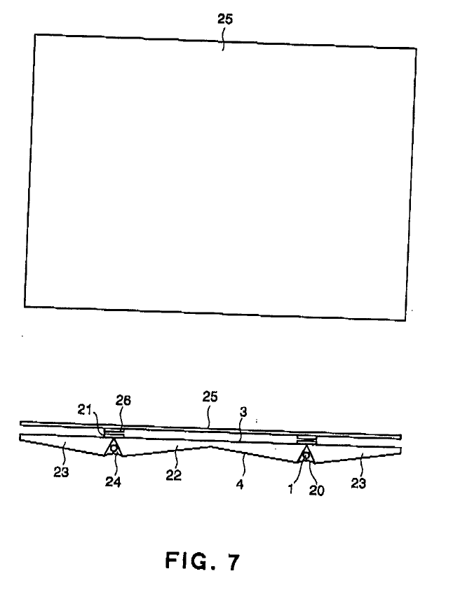

FIG. 7 is a front elevation illustrating a further example of a connected type light guide plate of the present invention, and a side elevation illustrating the same light guide plate. This connected type light guide plate has a double layer structure such that a diffusion sheet 25 is fitted on the connected type light guide plate shown in FIG. 6. Similarly to the connected type light guide plate shown in FIG. 6, a recess 24 is formed in each connection on the light reflecting surface side 4 between each light guide plate 23 having a single wing section and each light guide plate 22 having a two-wings section. A light source 1 is provided in the recess 24, and the recess 24 is covered by a reflector 20. A light control means 21 is fitted on the light emitting surface 3 at a position confronting the light source 1. Another light control means 26 is fitted on one side of the diffusion sheet 25, confronting the connected light guide plate, at a position confronting the light control means 21. The light control means 26 includes, for example, a light-reflecting prisms-shaped means, and a light blocking means printed with a black or white ink, which is printed, for example, in a dotted pattern.

By controlling the light beams transmitted directly from the light source 1 toward the emitting surface, by the light control means 21 fitted on the light emitting surface of the connected type light guide plate and by the light control means 26 fitted on the diffusion sheet 15, and further by providing the diffusion sheet 25, a large size display image having very uniform luminance can be obtained.

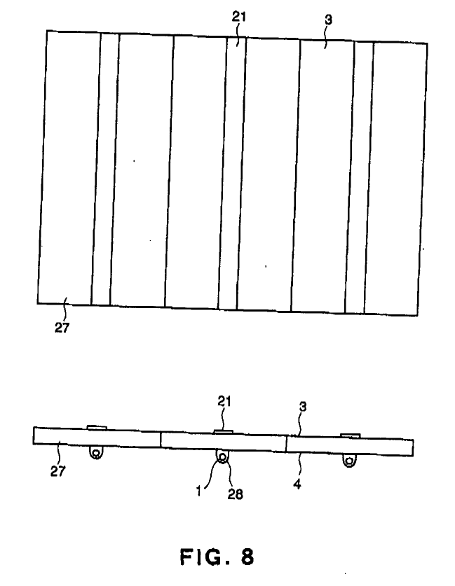

FIG. 8 is a front elevation illustrating a further example of a connected type light guide plate of the present invention, and a side elevation illustrating the same light guide plate. This connected type light guide plate is constituted by three light guide plates 27 each having a flat plate shape. A light source 1 is fitted at the center of the light reflecting surface 4 of each light guide plate 27, and the light source 1 is covered by a reflector 28. Each light guide plate 27 has a light control means 21 fitted on the light emitting surface 3 at a position confronting the light source 1. By controlling the light beams transmitted directly from the light source 1 toward the emitting surface 3 by the light control means 21, a large size display image having uniform luminance can be obtained. The light control means 21 includes, for example, a light-reflecting prisms-shaped means, and a light blocking means printed with a black or white ink, which is printed, for example, in a dotted pattern.

The connected type light guide plate shown in FIG. 8 is made from light guide plates having a simple and the same shape, and therefore the production cost is low. The flat plate-shaped light guide plates constituting the connected type light guide plate have approximately the same thickness, and therefore, they can be produced in a high yield even if the molding conditions are varied.

In the specific example shown in FIG. 8, three light guide plates each having a flat plate shape are connected. However, the number of flat plate-shaped light guide plates may be any of at least two. As a modification, a light guide plate having a one-piece structure can be made which has the same shape as the connected type light guide plate. The light guide plate having a one-piece structure has no seam and therefore a display image of very high quality can be obtained.

The connected type light guide plate shown in FIG. 8 can have a diffusion sheet laminated on the light emitting surface. As a modification, a single light guide plate having a flat plate shape may be used alone.

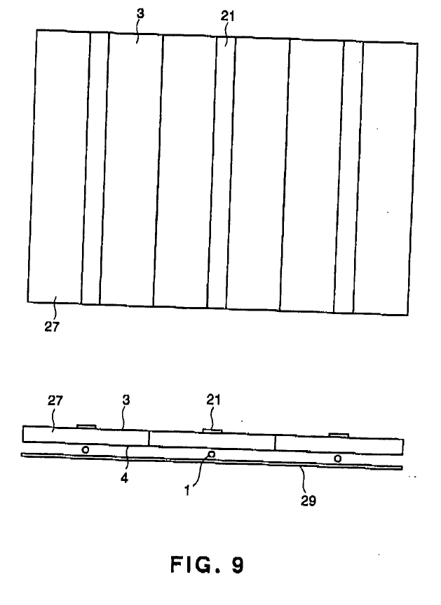

FIG. 9 is a front elevation illustrating a further example of a connected type light guide plate of the present invention, and a side elevation illustrating the same light guide plate. This connected type light guide plate is constituted by three light guide plates 27 each having a flat plate shape. A light source 1 is fitted at the center of the light reflecting surface 4 of each light guide plate 27. The light sources 1 and the entire light reflecting surface 4 are covered by a sheet-form reflector 29. Each light guide plate 27 has a light control means 21 fitted on the light emitting surface 3 at a position confronting the light source 1. By controlling the light beams transmitted directly from the light source 1 toward the emitting surface 3, a large size display image having uniform luminance can be obtained. The light control means 21 includes, for example, a light-reflecting prisms-shaped means, and a light blocking means printed with a black or white ink, which is printed, for example, in a dotted pattern.

The connected type light guide plate shown in FIG. 9 has fitted thereto a reflector having a simpler shape than that of the reflectors 28 in the connected light guide plate shown in FIG. 8, and further the connected type light guide plate shown in FIG. 9 is made from light guide plates having the same shape, and therefore the production cost is very low. The flat plate-shaped light guide plates constituting the connected type light guide plate have approximately the same thickness, and therefore, they can be produced in a high yield even if the molding conditions are varied.

In the specific example shown in FIG. 9, three light guide plates each having a flat plate shape are connected. The number of flat plate-shaped light guide plates may be any of at least two. As a modification, a light guide plate having a one-piece structure can be made which has the same shape as the connected type light guide plate. The light guide plate having a one-piece structure has no seam and therefore a display image of very high quality can be obtained.

The connected type light guide plate shown in FIG. 9 can have a diffusion sheet laminated on the light emitting surface. Due to the diffusion sheet, light beams returned to the connected type light guide plate are reduced, and thus, a high luminance can be obtained.

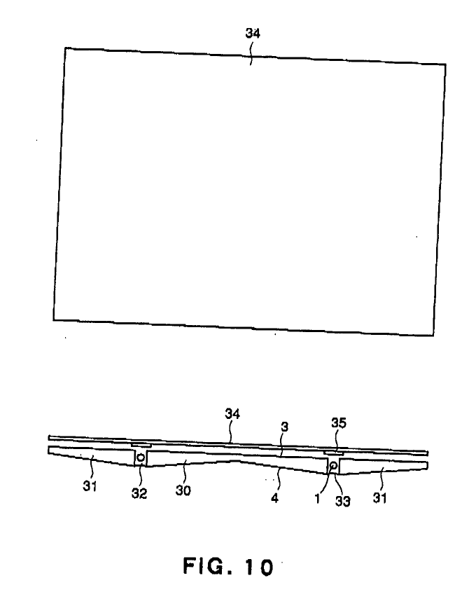

FIG. 10 is a front elevation illustrating a further example of a connected type light guide plate of the present invention, and a side elevation illustrating the same light guide plate. This connected type light guide plate is constituted by one light guide plate 30 having a two-wings section and two light guide plates 31 each having a single wing section. A light source 1 is fitted in space 32 between each light guide plate 31 having a single wing section and each light guide plate 30 having a two-wings section. The space 32 is covered by a reflector 33 fitted on the light reflecting surface side. The entire light emitting surface 3 of the connected light guide plate is covered by a diffusion sheet 34, and light control means 35 are fitted on the confronting side of diffusion sheet 34 at positions confronting the light sources 1. The light control means 35 include, for example, a light-reflecting prisms-shaped means, and a light blocking means printed with a black or white ink, which is printed, for example, in a dotted pattern. By controlling the light beams transmitted directly from the light source 1 toward the diffusion sheet 34 by the light control means 35 fitted on the diffusion sheet 34, a display image having uniform luminance can be obtained.

In the connected type light guide plate shown in FIG. 10, the greater part of light beams is transmitted directly from the light source into the light guide plate, and therefore, utilization efficiency of light is high. The distance of light transmission from the light source is short, and hence, the unevenness in luminance is greatly lowered. The connected type light guide plate is influenced by seams only to a minimized extent, and therefore, a display image having high quality can be obtained.

In the specific example shown in FIG. 10, a single light guide plate 30 having a two-wings section and two light guide plates 31 each having a wing section are connected. As modification, at least two light guide plates each having a two-wings section may be connected, and two light guide plates each having a wing section are connected to both ends of the connected at least two light guide plates. As another modification, two light guide plates each having a wing section may be used instead of a single light guide plate having a two-wings section, namely, the connected type light guide plate may be made only from light guide plates each having a wing section. This connected type light guide plate is made from one kind of light guide plate, and therefore, it is produced with a low cost.

The light guide plate for liquid crystal display according to the present invention has a surface layer portion comprising a region containing fluorine atoms in an amount larger than that in the inner layer portion. By the term “surface layer portion” as used herein, we mean a portion spanning from a depth 1 nm apart from the outermost surface of the light guide plate, to a depth 10 μm, preferably 5 μm, apart from the outermost surface thereof. The phrase “a surface layer portion comprising a region containing fluorine atoms in an amount larger than that in the inner layer portion” refers to that at least a part of the surface layer portion of the light guide plate contains fluorine atoms.

Both of the surface layer portion of the light guide plate and the inner layer portion thereof are composed of the same resin, and there is no interface between the surface layer portion and the inner layer portion. The content of fluorine atoms in the surface layer portion is larger than that in the inner layer portion. The content of fluorine atoms can be determined by X-ray electron spectroscopy (ESCA) or other analyzing means. The content of fluorine atoms may have a distribution such that the content decreases gradually or step-by-step from the surface layer portion to the inner layer portion.

The light guide plate for liquid crystal display according to the present invention is produced by a process comprising a step of exposing a surface of a light guide plate substrate made of a resin, to an atmosphere containing fluorine gas.

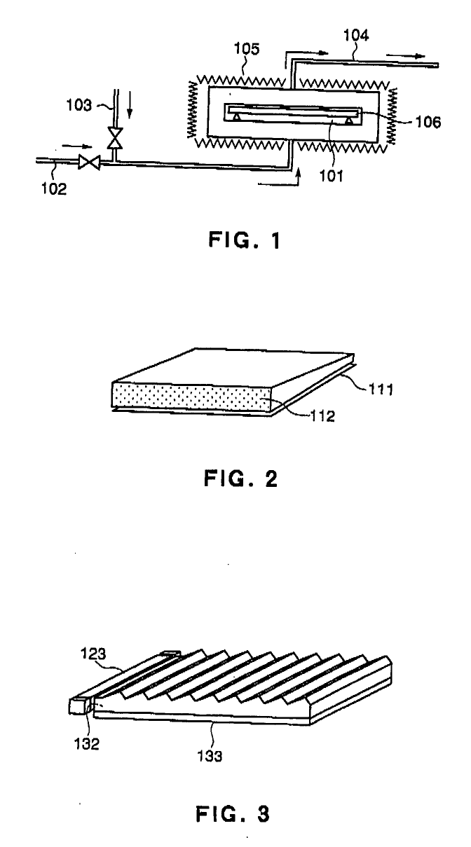

FIG. 1 is a diagram illustrating an example of a reaction apparatus used in the production process according to the present invention. This reaction apparatus has a chamber 101 and a heating apparatus 105 for controlling the temperature of the chamber 101. The chamber 101 is connected to a fluorine gas feed line 102 for feeding a fluorine gas into the chamber and an inert gas feed line 103 for feeding an inert gas into the chamber. An exhaust line 104 is connected to another part of the chamber 101 for exhaustion of gas. The chamber 101 has a space in which the above-mentioned light guide plate substrate is placed. The light guide plate substrate to be placed can have various shapes. The gas withdrawn through the exhaust line 104 can be, either as it is or after purification and separation, returned to the fluorine gas feed line and/or the inert gas feed line for re-use.

The light guide plate 106 is made by shaping a resin into a desired shape suitable for the size of a display surface. In the production process according to the present invention, when the light guide plate substrate is exposed to a fluorine gas-containing atmosphere to introduce fluorine atoms therein, the size of the substrate varies to a slight extent. Therefore, a consideration should be taken for the size of substrate to be shaped, so that a light guide having a desired size is produced therefrom. The shaping method may be conventional and includes, for example, extrusion shaping, injection molding, inflation, casting, blow-forming and vacuum-forming.

A preferred embodiment of the process for producing the light guide plate for liquid crystal display of the present invention comprises a step of placing the light guide plate substrate in an inert gas-containing atmosphere, or in the air under reduced pressure, prior to the step of exposing to a fluorine-gas containing atmosphere; and further comprises a step of again placing the light guide plate substrate in an inert gas-containing atmosphere, or in the air under reduced pressure, after the step of exposing to a fluorine-gas containing atmosphere. That is, the preferred embodiment of the production process comprise the following three steps: (1) a step of placing the light guide plate substrate in an inert gas-containing atmosphere, or in the air under reduced pressure, (2) a step of exposing a surface of the light guide plate substrate to a fluorine-gas containing atmosphere, and (3) a step of again placing the light guide plate substrate in an inert gas-containing atmosphere, or in the air under reduced pressure.

The above-mentioned three steps will be explained in detail.

(1) Step of Placing the Light Guide Plate Substrate Made of a Resin in an Inert Gas-Containing Atmosphere, or in the Air Under Reduced Pressure

This step (1) is not essential, but is preferable because the surface layer portion of the light guide plate can have the region containing a larger amount of fluorine atoms without in-plane distribution by conducting the step (1). In the step (1), a light guide plate substrate 106 is placed in a chamber 101. Then the chamber 101 is closed and a valve in an inert gas feed line 103 is opened to feed an inert gas into the chamber 101. The inert gas includes, for example, argon, nitrogen, helium, neon, krypton and xenon. Argon is preferably used in the present invention. The chamber 101 is preferably made of stainless steel or aluminum.

The atmosphere in the chamber 101 is substituted by an inert gas atmosphere, and then, the light guide plate substrate 106 in the chamber 101 is preferably heated. By heating the substrate, moisture, oxygen and volatile ingredients contained in the substrate can be effectively removed. The heating temperature is usually in the range from 60 to 180° C., preferably from 80 to 130° C., as the temperature of the substrate surface. The heating time is from 1 to 400 minutes, preferably from 2 to 300 minutes.

Instead of placing the light guide plate substrate in an inert gas-containing atmosphere, the substrate can be placed in the air under reduced pressure. In the case when the substrate is placed in the air under reduced pressure, the pressure is usually not higher than 500 mmHg, preferably not higher than 100 mmHg. The lower limit of the pressure is 1 mmHg. If the pressure is reduced to an excessive extent, oil, moisture and other waste material tend to return from an exhaust line 104. The heating temperature is usually maintained in the range from 15 to 100° C. Simultaneously with the pressure reduction, a high-purity inert gas can be introduced whereby oxygen and moisture can be effectively removed. The time of maintaining the substrate under reduced pressure is in the range from 1 to 400 minutes, preferably from 1 to 300 minutes.

If oxygen and moisture are present in the substrate, the surface of the substrate is easily made hydrophilic in the succeeding step (2). Therefore the content of oxygen and moisture should preferably be reduced in the step (1). The content of each of oxygen and moisture in the light guide plate substrate is usually not larger than 1% by weight, preferably not larger than 100 ppm by weight, and more preferably not larger than 10 ppm by weight.

(2) Step of Exposing a Surface of the Light Guide Plate Substrate to a Fluorine-Gas Containing Atmosphere

After completion of the step (1), a valve in the inert gas feed line 103 is closed, and, if desired, the chamber 101 is cooled. Then a valve in the fluorine gas feed line is opened and, the valve in the inert gas feed line 103 is opened according to the need. Thereby a fluorine gas is fed into the chamber 101, and the atmosphere in the chamber 101 is substituted by a fluorine gas-containing atmosphere.

The fluorine gas-containing atmosphere may be composed only of fluorine gas, but is preferably composed of a fluorine gas diluted with an inert gas to proceed the reaction at a moderate rate. The fluorine gas-containing atmosphere is preferably substantially free from oxygen and moisture. More specifically the content of each of oxygen and moisture is preferably not larger than 100 ppm by weight, more preferably not larger than 10 ppm by weight and especially preferably not larger than 1 ppm by weight.

By exposing a surface of the light guide plate substrate to a fluorine gas-containing atmosphere, a fluorine gas is gradually introduced from the surface of the light guide plate substrate to the surface layer portion and further to the inner layer portion, whereby fluorine atoms are gradually introduced within the resin molecule and the content of fluorine atoms in the resin constituting the light guide plate substrate is increased. The depth of fluorine atoms permeated from the outermost surface of the light guide plate substrate, and the content of fluorine atoms vary depending upon the concentration of fluorine gas, the temperature and the time.

The fluorine gas diluted with an inert gas contains a fluorine gas at a concentration usually in the range from 0.1 to 50% by volume, preferably from 0.1 to 30% by volume and more preferably from 0.1 to 20% by volume. The surface temperature of the light guide plate substrate at which the surface of the substrate is placed in contact with fluorine gas is not particularly limited, but is usually maintained in the range from −50 to 150° C., preferably from −20 to 80° C. and more preferably from 0 to 50° C. The contact time is usually in the range from 0.1 second to 600 minutes, preferably from 0.5 second to 300 minutes and more preferably from 1 second to 60 minutes. When the concentration of fluorine gas is high, the temperature is high or the contact time is long, the depth of permeated fluorine atoms becomes large, and the content of fluorine atoms in the substrate increases.

With an increase in the content of fluorine atoms, the refractive index of the fluorine atoms-introduced portion, especially the fluorine atoms-introduced surface layer portion, decreases. By appropriately selecting the concentration of fluorine gas, the temperature and the time, the substrate having a desired refractive index can be obtained. To reduce the light light reflectivity, the difference between the refractive index of the surface layer portion and the refractive index of the inner layer portion is preferably at least 0.001, more preferably at least 0.01. When the concentration of fluorine gas is too high, or the contact temperature is too high and the contact time is too long, the resin constituting the light guide plate substrate is deteriorated. Therefore the contact with fluorine gas should preferably be carried out in the above-mentioned ranges.

(3) Step of, after Exposure to the Fluorine Gas-Containing Atmosphere, Placing the Light Guide Plate Substrate Having been Treated with Fluorine Gas, Again in an Inert Gas-Containing Atmosphere, or in the Air Under Reduced Pressure

After a predetermined time elapses from the exposure to the fluorine gas-containing atmosphere, an inert gas feed line 103 is opened and a valve in a fluorine gas feed line 102 is closed whereby the chamber 101 is filled with an inert gas atmosphere. The inert gas includes those which are mentioned in the above-mentioned step (1). The light guide plate substrate 106 is preferably heated by a heating means 105. By heating, excessive fluorine gas not having introduced in the substrate can be removed. The heating temperature is usually in the range from 60 to 180° C., preferably 80 to 130° C., as the temperature of the substrate surface. The heating time is 1 to 400 minutes, preferably 1 to 300 minutes.

Instead of placing the substrate in an inert gas-containing atmosphere, the substrate can be placed in the air under reduced pressure. In the case when the substrate is placed in the air under reduced pressure, the pressure is usually not higher than 500 mmHg, preferably not higher than 100 mmHg. The lower limit of the pressure is 1 mmHg. If the pressure is reduced to an excessive extent, oil, moisture and other waste material tend to return from an exhaust line. When the substrate is placed in the air under reduced pressure, the heating temperature is usually maintained in the range from 15 to 100° C. Simultaneously with the pressure reduction, a high-purity inert gas is preferably introduced whereby fluorine gas not having been introduced can be effectively removed. The time of maintaining the substrate under reduced pressure is in the range from 1 to 400 minutes, preferably from 1 to 300 minutes.

The step (3) is not essential, but is preferable because the surface layer portion of the light guide plate can have the region containing a larger amount of fluorine atoms without in-plane distribution by conducting the step (3).

After completion of the step (3), the light guide plate is taken from the chamber, and can be applied for various uses.

### EXAMPLES

The invention will now be described specifically by the following examples and comparative example. The invention is by no means limited by the examples.

### Example 1

An alicyclic structure-having resin (ZEONOR™ 1430R available from Zeon Corporation) was molded into a wedge shaped light guide plate substrate having a short side with 53.8 mm, a long side with 71.5 mm, a thickness from 2.0 mm at the light incident side and a thickness from 1.6 mm at the opposite side. The molding was conducted by using an injection molding machine α-100B (available from FANUC Ltd.) at a mold temperature of 110° C. and a cylinder temperature of 290° C. Except for a light incident surface of the substrate, all of the other surfaces thereof including a light emitting surface and a light reflecting surface were masked. The masked light guide plate substrate was placed in a stainless steel vessel where the substrate was maintained at 100° C. for 3 hours in a stream of high-purity argon having an oxygen content of not larger than 1 ppb by weight and a moisture content of not larger than 1 ppb by weight, to remove oxygen and moisture. The content of each of oxygen and moisture in the substrate was smaller than 10 ppm by weight. The substrate was cooled to room temperature, and, a valve was switched carefully so as to avoid the penetration of oxygen and moisture from the outside air, whereby a fluorine gas diluted with argon gas, having a fluorine content of 1% by weight (an oxygen content of smaller than 1 ppm by weight and a moisture content of smaller than 1 ppm) was introduced in the vessel at 20° C. After 20 minutes elapsed, the valve was switched and high-purity argon having an oxygen content of smaller than 1 ppm by weight and a moisture content of smaller than 1 ppm was introduced. The substrate was maintained at 100° C. for 1 hour to remove excessive fluorine gas.

The masking was peeled from the substrate, and a back-light device as shown in FIG. 2 was assembled as follows. A cold cathode tube (not shown) and a reflector (not shown) were fitted to the substrate so that the cold cathode tube and the reflector were in parallel to the light incident surface 112 having been contacted with fluorine gas. A white reflection sheet 111 (E60L available from Toray Industries, Inc.) was laminated on the light reflecting surface to make the back-light device. The cold cathode tube was turned on, and the luminance of the back-light device was evaluated by a luminance meter (“CA-1500” available from Konica Minolta Holdings, Inc.). The luminance was 805 cd/m².

### Comparative Example 1

An alicyclic structure-having resin (ZEONOR™ 1430R available from Zeon Corporation) was molded into a wedge shaped light guide plate substrate having a short side with 53.8 mm length, a long side with 71.5 mm length, a thickness of 2.0 mm at the light incident side and a thickness of 1.6 mm at the opposite side. The molding was conducted by using an injection molding machine α-100B (available from FANUC Ltd.) at a mold temperature of 110° C. and a cylinder temperature of 290° C. Using the light guide plate substrate, a back-light device having a structure as shown in FIG. 2 was made by the same procedures as described in Example 1 except that the exposure of the substrate to fluorine gas was not carried out. The luminance of the back-light device was 776 cd/m².

### Example 2

An alicyclic structure-having resin (ZEONOR™ 1430R available from Zeon Corporation) was molded into a light guide plate substrate having a structure having a prisms-shaped ribbed surface as shown in FIG. 3 which had a short side with 53.8 mm length, a long side with 71.5 mm length, and a thickness of 2.0 mm. Except for a side face (light incident surface 132) and a surface (light emitting surface 133) confronting the prisms-shaped ribbed surface, all of the other surfaces of the substrate were masked. The masked light guide plate substrate was placed in a stainless steel vessel where the substrate was maintained at 100° C. for 3 hours in a stream of high-purity argon having an oxygen content of not larger than 1 ppb by weight and a moisture content of not larger than 1 ppb by weight, to remove oxygen and moisture. The content of each of oxygen and moisture in the substrate was smaller than 10 ppm by weight.

The substrate was cooled to room temperature, and, a valve was switched carefully so as to avoid the penetration of oxygen and moisture from the outside air, whereby a fluorine gas diluted with argon gas, having a fluorine content of 1% by weight (an oxygen content of smaller than 1 ppm by weight and a moisture content of smaller than 1 ppm) was introduced in the vessel at 20° C. After 20 minutes elapsed, the valve was switched and high-purity argon having an oxygen content of smaller than 1 ppm by weight and a moisture content of smaller than 1 ppm was introduced. The substrate was maintained at 100° C. for 1 hour to remove excessive fluorine gas.

The masking was peeled from the substrate, and a cold cathode tube and a reflector 123 were fitted to the long side face of the substrate. The thus-obtained light guide plate assembly was placed on a reflection type liquid crystal display taken from a commercially available portable game player, and the visibility of images were evaluated. Moire phenomenon was not observed, and the front-light light guide plate exhibited good visibility.

### INDUSTRIAL APPLICABILITY

The light guide plate for liquid crystal display according to the present invention is useful as a light guide plate for use in a liquid crystal display device for various electronic instruments such as personal computers and televisions.

1. A light guide plate for liquid crystal display, which comprises a light guide plate made of a resin and having a surface layer portion comprising a region containing fluorine atoms in an amount larger than that in the inner layer portion.

2. The light guide plate for the liquid crystal display according to claim 1, wherein the light guide plate has the surface layer portion comprising a region containing a larger amount of fluorine atoms is on the light-incident side of the light guide plate.

3. The light guide plate for the liquid crystal display according to claim 1, wherein the resin is an alicyclic structure-containing resin.

4. The light guide plate for liquid crystal display according to claim 3, wherein the alicyclic structure-containing resin is selected from the group consisting of ring-opening polymerization polymers of norbornene monomers, and hydrogenation products thereof; addition polymerization polymers of norbornene monomers; addition copolymerization copolymers of norbornene monomers with a vinyl monomer; polymers of monocycloalkene monomers; polymers of alicyclic conjugated diene monomers, and hydrogenation products thereof; polymers of vinyl-alicyclic hydrocarbon monomers, and hydrogenation products thereof; and aromatic ring-hydrogenated products of aromatic olefin polymers.

5. A process for producing a light guide plate for liquid crystal display, which comprises a step of exposing a surface of a light guide plate substrate made of a resin, to an atmosphere containing fluorine gas.

6. The process for producing the light guide plate for the liquid crystal display according to claim 5, which comprises a step of placing the light guide plate substrate in an inert gas-containing atmosphere, or in the air under reduced pressure, prior to the step of exposing to a fluorine-gas containing atmosphere; and further comprises a step of placing the light guide plate substrate again in an inert gas-containing atmosphere, or in the air under reduced pressure, after the step of exposing to a fluorine-gas containing atmosphere.

7. The process for producing the light guide plate for the liquid crystal display according to claim 5, wherein the resin is an alicyclic structure-containing resin.

8. The process for producing the light guide plate for the liquid crystal display according to claim 5, wherein the fluorine gas-containing atmosphere contains a fluorine gas at a concentration in the range from 0.1 to 50% by volume and further contains an inert gas.

9. The process for producing the light guide plate for the liquid crystal display according to claim 5, wherein the content of each of oxygen and moisture in the light guide plate substrate immediately before the step of exposing to a fluorine-gas containing atmosphere is not larger than 1% by weight.

10. The process for producing the light guide plate for the liquid crystal display according to claim 5, wherein the content of each of oxygen and moisture in the fluorine-gas containing atmosphere immediately before the step of exposing thereto the surface of the light guide plate substrate is not larger than 100 ppm by weight.

11. The process for producing the light guide plate for the liquid crystal display according to claim 5, wherein the surface of the light guide plate substrate is exposed to the fluorine gas-containing atmosphere while the surface of the light guide plate substrate is maintained at a temperature in the range from −50 to 150° C.

12. The process for producing the light guide plate for the liquid crystal display according to claim 5, which comprises a step of maintaining the light guide plate substrate at a temperature in the range from 60 to 180° C. in an atmosphere containing an inert gas, prior to the step of exposing to the fluorine-gas containing atmosphere; and further comprises a step of maintaining the light guide plate substrate again at a temperature in the range from 60 to 180° C. in an atmosphere containing an inert gas, after the step of exposing to the fluorine-gas containing atmosphere.

13. The process for producing the light guide plate for the liquid crystal display according to claim 5, which comprises a step of maintaining the light guide plate substrate at a temperature in the range from 15 to 100° C. in the air under reduced pressure, prior to the step of exposing to the fluorine-gas containing atmosphere; and further comprises a step of maintaining the light guide plate substrate again at a temperature in the range from 15 to 100° C. in the air under reduced pressure, after the step of exposing the surface of the light guide plate to the fluorine-gas containing atmosphere.

14. The process for producing the light guide plate for the liquid crystal display according to claim 5, which comprises a step of maintaining the light guide plate substrate in the air under a pressure in the range from 1 to 500 mmHg, prior to the step of exposing to the fluorine-gas containing atmosphere; and further comprises a step of maintaining the light guide plate substrate again in the air under a pressure in the range from 1 to 500 mmHg, after the step of exposing the surface of the substrate to the fluorine-gas containing atmosphere.
